(19) United States
(12) Patent Application Publication
(10) Pub. No.: US 2006/0282239 A1
(43) Pub. Date: Dec. 14, 2006

(54) Method of setting-up steady state model of VSC-based multi-terminal HVDC transmission system

(75) Inventors: Chia-Chi Chu, Tao-Yuan (TW); Sheng-Huei Lee, Tao-Yuan (TW); Hung-Chi Tsai, Tao-Yuan (TW)

Correspondence Address: NIKOLAI & MERSEREAU, P.A., 900 SECOND AVENUE SOUTH, SUITE 820, MINNEAPOLIS, MN, 55402, US

(73) Assignee: Chang Gung University, Tao-Yuan (TW)

(21) Appl. No.: 11/148,084

(22) Filed: Jun. 8, 2005

(51) Int. Cl. G06F 17/10

(52) U.S. Cl. 703/2

(57) ABSTRACT

The power flow model of the multiterminal voltage-source converter-based high voltage DC (M-VSC-HVDC) transmission system for large-scale power systems is studied. The mathematical model is derived using the d-q axis decomposition of HVDC's control parameter. The developed model can be applied to all existing shunt voltage-source converter (VSC) based controllers, including Static Synchronous Compensator (STATCOM), point-to-point HVDC system, back-to-back HVDC system and multiterminal HVDC system. A unified procedure is developed for incorporating the proposed model into the conventional Newton-Raphson power flow solver. The IEEE 300-bus test system embedded with multiple HVDC transmission systems under different configurations are investigated. Simulation results reveal that the proposed model is effective and accuracy in meeting various control objectives.

### BACKGROUND OF THE INVENTION

1. Field of the Invention

The present invention relates generally to a steady state model of a multi-terminal high-voltage direct current based on voltage source converter (VSC) (referred to as M-VSC-HVDC), and more particularly to an improved one that can be applied for analysis of power flow of large power system. And, the voltage phasor/current vector relating to control parameters of HVDC transmission system and voltage source converter (VSC) are decomposed into direct-axis components and quadrature-axis components for further derivation.

2. Description of Related Art

Electricity/electronics technology was firstly applied to control of power system at 1970s, one example of which is HVDC transmission system;

HVDC transmission system was developed by Y. H. Song and A. T. Johns in Flexible AC Transmission Systems (FACTS) (vol. 30. London, United Kingdom: The Institution of Electrical Engineers, 1999).

In general, the framework of HVDC transmission system incorporated into AC power grid can be divided into three categories:

1. Back-to-Back (BTB) HVDC Transmission System:

Initiated by A. E. Hammad Z and W. F. Long in “Performance and Economic Comparisons between Point-to-Point HVDC Transmission and Hybrid Back-to-Back HVDC/AC Transmission,” (IEEE Transactions on Power Delivery, vol. 5, 1990, pp. 1137-1144).

The rectifier end and converter end, mounted into the same transformer station, are generally applied to connect two asynchronous systems of different voltages or frequencies;

2. Point-to-Point (PTP) HVDC Transmission System:

Initiated by A. E. Hammad and W. F. Long in “Performance and Economic Comparisons Between Point-to-Point HVDC Transmission and Hybrid Back-to-Back HVDC/AC Transmission,” (IEEE Transactions on Power Delivery, vol. 5, 1990, pp. 1137-1144).

Two remotely spaced AC power grids are interconnected via HVDC transmission system. The rectifier end of HVDC transmission system is often linked to the bus of power plant, and converter end linked to the bus of load center. Currently, PTP framework accounts for more than half of applied HVDC system.

3. Multi-terminal HVDC:

Initiated by G. Morin, L. X. Bui, S. Casoria, and J. Reeve in “Modeling of the Hydro-Quebec-New England HVDC System and Digital Controls with EMTP,” (IEEE Transactions on Power Delivery, vol. 8, 1993, pp. 559-566.), H. Jiang and A. Ekstrom in “Multi-terminal HVDC Systems in Urban Areas of Large Cities,” (IEEE Transactions on Power Delivery, vol. 13, 1998, pp. 1278-1284);

Multi-terminal HVDC transmission system is fitted with at least two voltage source converters (VSC). There is only one Multi-terminal HVDC transmission system currently in use across the world, which is built-into Hydro Quebec-New England transmission system. Its power supply is sourced from La Grande II hydraulic power plant, converted into DC voltage at Radisson transformer station, and then separately fed to load center at Montreal and Boston via DC transmission line;

Nonetheless, according to most of common technical papers, HVDC steady state model for power flow analysis requires a fundamental and important task. Moreover, planning engineers of power system evaluate the impact of HVDC transmission system upon bus voltage and flow distribution of transmission line based on analysis of power flow.

Despite of numerous researches involving HVDC technology, more efforts were focused on discussion of dynamic performance, other than setting-up of steady state model of HVDC;

The steady state model of thyristor-based traditional HVDC was developed and given a detailed description by J. Arrillaga and N. R. Watson in Computer Modelling of Electrical Power Systems (New York: John Wiley & Sons, 2001). Meanwhile, the steady state model of VSB-based HVDC was developed by C. Angeles-Camacho, O. L. Tortelli, E. Acha, and C. R. Fuerte-Esquivel, in “Inclusion of a High Voltage DC-Voltage Source Converter Model in a Newton-Raphson Power Flow Algorithm,” (IEE Proceedings. Generation, Transmission and Distribution, vol. 150, 2003, pp. 691-696). And, they successfully incorporated aforesaid steady state models into Newton-Raphson Power Flow Algorithm. However, it's not suitable for configuration of Multi-terminal HVDC transmission system, and the coupling transformer only takes into account of reactance other than resistance;

Thus, to overcome the aforementioned problems of the prior art, the inventor has provided a method and solution of setting-up steady state model of M-VSC-HVDC of practicability after numerous tests and modifications based on his years of experience in the production, development and design of related products.

### SUMMARY OF THE INVENTION

The main objective of present invention is to provide a method of setting-up a steady state model of VSC-based Multi-terminal high-voltage DC (referred to as M-VSC-HVDC), which fully considers the loss of coupling transformer, control objective of active power and the conditions for compensation of reactive power and balance of active power.

To achieve the objective, the present invention intends to provide a method of setting-up a steady state model of VSC-based Multi-terminal high-voltage DC (referred to as M-VSC-HVDC) suitable for analysis of power flow of large power system. When Newton-Raphson iteration method is used to calculate system flow solution, the steady state model of HVDC is expressed as a d-q axis component via Park Conversion using orthogonal projection technology, thus reducing the complexity of computational analysis;

When the system is to calculate power flow solution, M-VSC-HVDC model is incorporated into Newton-Raphson algorithm, and a little HVDC control parameters are added to iteration formula. In despite of the amount of parallel voltage source converters (VSC) and control mode of reactive power compensation, the number of mismatch vector increases only by 1, while little element in Jacobian shall be modified. Therefore, quadratic convergence of Newton-Raphson algorithm is still maintained, presenting a good convergence characteristic;

Thus, based on the derived d-q axis components of control parameters of HVDC system, it shall be possible to implement different reactive power compensation modes and HVDC frameworks in a single flow process. And, it fully considers the loss of coupling transformer, control objective of active power and the conditions for compensation of reactive power and balance of active power.

The other features and advantages of the present invention will be more readily understood upon a thoughtful deliberation of the following detailed description of a preferred embodiment of the present invention with reference to the accompanying drawings and icons. However, it should be appreciated that the present invention is capable of a variety of embodiments and various modifications by those skilled in the art, and all such variations or changes shall be embraced within the scope of the following claims.

### BRIEF DESCRIPTION OF THE DRAWINGS

FIG. 1 shows a wiring diagram of M-VSC-HVDC transmission system linking a power system.

FIG. 2 shows a circuit diagram of M-VSC-HVDC transmission system of the present invention.

FIG. 3 shows the flow chart of setting-up M-VSC-HVDC transmission system model with introduction of Newton-RaphsonPower Flow Algorithm.

FIG. 4 depicts the trend of maximal error of mismatch vector.

FIG. 5 shows a convergence mode for maximum absolute value of mismatch vector of the present invention.

### DETAILED DESCRIPTION OF THE INVENTION

According to HVDC system in power industry, some electricity/electronics technologies are used to receive active power of AC power grid at rectifier end, convert ACV into DCV, and then transmit to converter end via DC transmission line, where DC is converted into AC and fed to AC power grid. With the help of HVDC transmission system, active power through DC transmission line can be controlled in an accurate and rapid manner.

In addition, input reactive power at terminals of HVDC transmission system can be independently controlled using its own DC capacitors. Therefore, HVDC transmission system is often used to improve the performance and efficiency of AC power grid.

However, HVDC steady state model for power flow analysis requires a basic and important task. Moreover, planning engineers of power system evaluate the impact of HVDC transmission system upon bus voltage and flow distribution of transmission line based on analysis of power flow.

Despite of numerous researches involving HVDC technology, more efforts were focused on discussion of dynamic performance, other than setting-up of steady state model of HVDC. The steady state model of VSB-based HVDC was initiated in 2003, and then incorporated successfully into Newton-Raphson Power Flow Algorithm.

In this model, two parallel voltage sources represent VSC, and series reactance linked to voltage source represents the coupling transformer, but is not suitable for configuration of Multi-terminal HVDC transmission system; And, voltage range and phase angle of parallel voltage source are considered as status variables and inducted into iteration formula, whereas coupling transformer only takes reactance into account other than resistance.

The present invention intends to provide a mathematical model of VSC-based Multi-terminal HVDC transmission system, which can be inducted into Newton-Raphson Power Flow Algorithm, and expanded to all controllers composed of parallel voltage source converters (VSC).

Every terminal of HVDC transmission system is represented by a voltage source, which includes two orthogonal components: direct-axis component and quadrature-axis component, both of which are coupled according to an active power balance equation.

The advantage or d-q axis decomposition is: the active and reactive power fed into AC power grid from VSC can be fully decoupled, and little status variables are inducted into iteration formula, thus ensuring that the model can realize various expected control objectives in an efficient and accurate manner.

Steady State Model of Voltage Source Converter(VSC)-based Multi-terminal High-Voltage Direct Current(M-VSC-HVDC)

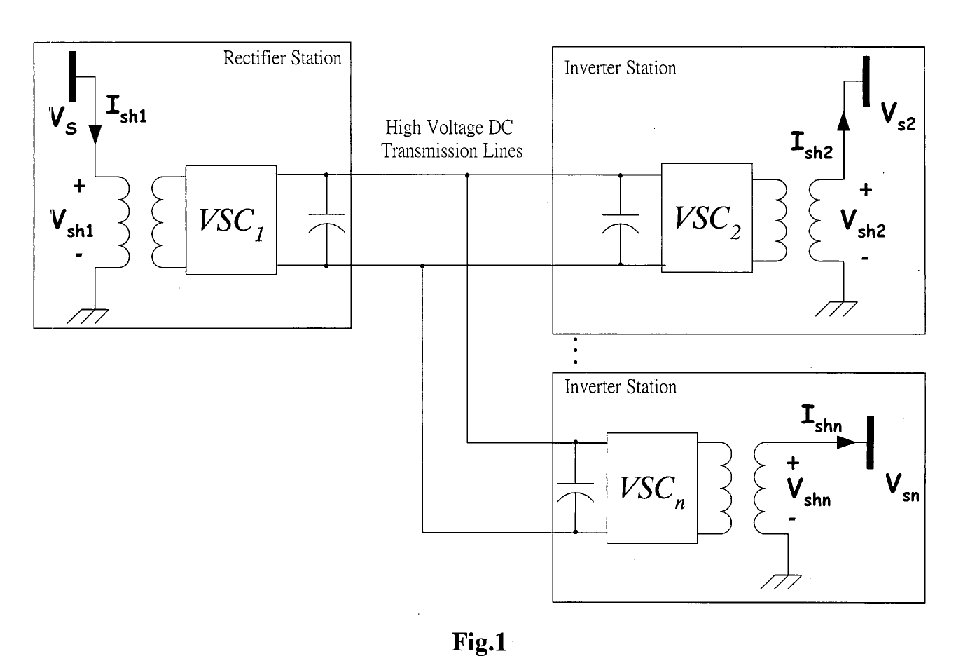

As shown in FIG. 1, VSC-based Multi-terminal HVDC transmission system comprises several switching converters. The converter's DC side is interlinked by DC transmission line, and AC side linked to AC power grid via coupling transformer. If average active power flows from AC side to DC side of VSC, VSC operates in the rectifier mode, otherwise, in the converter mode. Every VSC enables the DC capacitor to provide reactive power compensation independently controlled, while the active power can be exchanged through DC terminal.

VSC-based Multi-terminal HVDC transmission system comprises one rectifier end and one or more converter ends. In the present invention, VSC₁ acts as a rectifier end, which is responsible for balancing active power sent out from converter end. The implied limiting conditions are: active power absorbed by VSC₁ is limited, and only reactive power can be controlled independently. VSC₂-VSCₙ are considered as converter ends, from which active and reactive power fed to AC power grid can be controlled independently.

Control Mode of Compensation of Parallel Reactive Power

Since DC side of VSC is fitted with a DC capacitor, various terminals of HVDC are able to provide an independent control of reactive power. According to the control objective of parallel reactive power compensation, four control modes for reactive power compensation are taken into account by the present invention:

1. Mode 1: control the voltage range at both rectifier end and converter end.

2. Mode 2: control the voltage range at rectifier end and input reactive power at converter end.

3. Mode 3: control input reactive power at rectifier end and voltage range at converter end.

4. Mode 4: control input reactive power at rectifier end and converter end.

Equivalent Circuit of VSC-Based Multi-terminal High-Voltage Direct Current (M-VSC-HVDC)

The following paragraph discusses how to derive an equivalent circuit required for analysis of power flow. The major feature of steady state model of the present invention lies in that control parameters of HVDC transmission system are represented by means of rectangular coordinates. Every VSC selects separately the connected bus's voltage phasor as a reference phasor, of which direct-axis component and reference phasor are in the same phase, and quadrature-axis component is orthogonal to the reference phasor. d-q axis decomposition of related variables can be obtained from following projection computation:
Iₛₕₖ^{D}+jIₛₕₖ^{Q}=Iₛₕₖe^{j(θ}^{ₛₕₖ}^{-θ}^{sk)}, (1)

Where, upper “D” and “Q” represent direct-axis component and quadrature-axis component of specified variable respectively, while lower “k” is the serial number of VSC.

With direct-quadrature-axis components of related control variables, the present invention intends to set up a new steady state model of voltage source converter (VSC)-based Multi-terminal high-voltage DC;

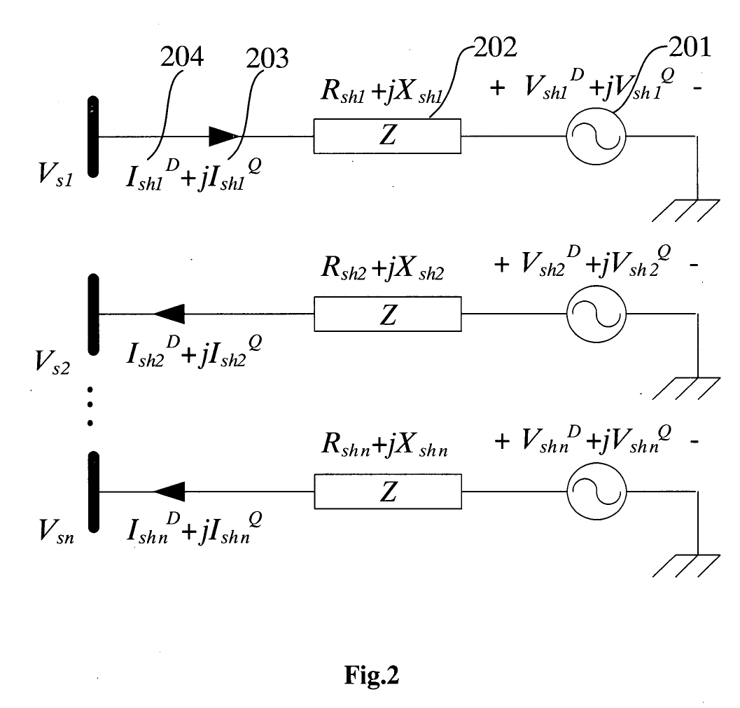

As shown in FIG. 2, every VSC selectively utilizes the connected bus's voltage phasor (201), and Z is equivalent impedance of coupling transformer (202). Moreover, every terminal of HVDC is represented by a current source, which includes two components: direct-axis component Iₛₕₖ^{D} of resistive current(204) and quadrature-axis component Iₛₕₖ^{Q} of capacitive current(203). The resistive current is used to represent active power transfer among VSCs and active power loss of coupling transformer. The capacitive current is used to represent independent reactive power control capability of converter. Since a balanced active power must be maintained between voltage source converters (VSC), active power of various converters is not compensated independently of each other. If assuming that all voltage source converters (VSC) don't generate any loss, the active power received at rectifier end would be equal to total active power sent out at converter end plus the loss of DC transmission line. Thus, active power's balance equation can be expressed as:
P_{dc}=Pₛₕ₁−Σₖ₋₂ⁿ(Pₛₕₖ+Pₗₒₛₛ^{k})=0, (2)

Where, Pₛₕₖ is active power fed to AC power grid by VSCₖ, and Pₗₒₛₛ^{k} is the loss of active power of DC transmission line linking bus s₁ and among bus sₖ.

In addition to analysis of power flow of Multi-terminal HVDC transmission system, this model can be simplified into a PTP HVDC transmission system if n is set as 2. Furthermore, if R_{dc}^{(1k)} is set as zero, it indicates a BTB HVDC system. In addition, if formula (2) is replaced by P_{dc}=Pₛₕ₁, it indicates just a static synchronous compensator of parallel voltage source converter (VSC). Therefore, static synchronous compensator may be deemed as a special example of this model.

Power Flow Model of VSC-Based Multi-terminal High-Voltage Direct Current

Equivalent Load of VSC-Based Multi-terminal HVDC Terminal

In the present invention, each terminal of VSC-based Multi-terminal HVDC is replaced by an equivalent nonlinear load. The capacity of equivalent load depends on the control objectives and terminal voltage, and updated during every iteration operation;

According to the definition of complex power and representation of d-q axis component, the equivalent load at rectifier end is expressed as:

$$[ \begin{matrix}{P}_{s 1} \\ {Q}_{s 1}\end{matrix} ] = [ \begin{matrix}{V}_{s 1} & 0 \\ 0 & - {V}_{s 1}\end{matrix} ] [ \begin{matrix}{I}_{sh 1}^{D} \\ {I}_{sh 1}^{Q}\end{matrix} ] , \qquad ( 3 )$$

Where, Iₛₕ₁^{D} is considered as a status variable, which can be automatically adjusted to balance the active power between voltage source converters (VSC);

When VSC₁ operates in an automatic voltage control mode, Iₛₕ₁^{Q} is also considered as a status variable, which can be automatically adjusted to maintain the voltage of bus s₁ at a preset level. To the contrary, if VSC₁ intends to control the inputs of specified reactive power, Iₛₕ₁^{Q} can be calculated from the following formula:

$${I}_{sh 1}^{Q} = \frac{{Q}_{s 1}^{ref}}{{V}_{s 1}} , \qquad ( 4 )$$

Where, Qₛ₁^{ref} is the target value of input reactive power for bus s₁. The equivalent load at converter end can be calculated in a similar way.

$$[ \begin{matrix}{P}_{sk} \\ {Q}_{sk}\end{matrix} ] = - [ \begin{matrix}{V}_{sk} & 0 \\ 0 & - {V}_{sk}\end{matrix} ] [ \begin{matrix}{I}_{shk}^{D} \\ {I}_{shk}^{Q}\end{matrix} ] . \qquad ( 5 )$$

HVDC transmission system is primarily aimed at transferring specified active power over DC transmission lines, so Iₛₕₖ^{D} can be directly determined by the control objective of active power.

$${I}_{shk}^{D} = \frac{{P}_{sk}^{ref}}{{V}_{sk}} , \qquad ( 6 )$$

Where, Pₛₖ^{ref} is the target value of active power sent out from bus sₖ

When VSCₖ operates in an automatic voltage control mode, Iₛₕₖ^{Q} is considered as a status variable. If you intends to control the specified input reactive power, Iₛₕₖ^{Q} can be calculated by the following formula:

$${I}_{shk}^{Q} = - \frac{{Q}_{sk}^{ref}}{{V}_{sk}} , \qquad ( 7 )$$

Where, Qₛₖ^{ref} is the target value of input reactive power for bus sₖ.

Active Power Compensation of Converter

At rectifier end of HVDC transmission system, active power absorbed by VSC is equal to the active power absorbed by bus s₁ minus the loss of active power of coupling transformer, which is illustrated by the following mathematical expression:
Pₛₕ₁=Iₛₕ₁^{D}Vₛ₁−(Iₛₕ₁^{D}^{²}+Iₛₕ₁^{Q}^{²})Rₛₕ₁. (8)

Since the defined current direction at converter end differs from that at rectifier end, the active power fed to AC power grid from vscₖ is:
Pₛₕₖ=Iₛₕₖ^{D}Vₛₖ+(Iₛₕₖ^{D}^{²}+Iₛₕₖ^{Q}^{²})Rₛₕₖ. 9)

This paragraph gives a description of the loss of active power arising from DC transmission line. The voltage of DC terminal shall remain constant under a normal and steady operation. In the case of an assumed 1.0 per unit value (p.u.) and absence of active power loss for VSC, the active power loss of DC transmission line can be expressed as:
Pₗₒₛₛ^{k}=Pₛₕₖ²R_{dc}^{k}, (10)
Where, R_{dc}^{k} is the resistance of DC transmission line linking VSC₁ and among VSCₖ;
If substituting formulas (8), (9), and (10) into formula (2), the balance equation of active power is made available.

Incorporating VSC-Based Multi-terminal High-Voltage Direct Current (M-VSC-HVDC) Model into Newton-Raphson Algorithm

When Newton-Raphson Algorithm is applied to power flow equation, the solution can be calculated by the following iteration equation:
x^{(k+1)}=x^{(k)}+J⁻¹ƒ(x) (11)
Where, x refers to unknown variables including voltage range and phase angle of busses and independent control variables of HVDC transmission system; ƒ(x) refers to mismatch vector used to describe the equilibrium relationship of active/reactive power of various busses and limiting conditions of HVDC transmission system; J is a Jacobian matrix generated from a partial differentiation of mismatch vector. Since every terminal of HVDC transmission system is replaced by nonlinear load, the relative position in mismatch vector shall be modified. Besides, mismatch vector shall also be added into active power's balance equation with the induction of VSC-based Multi-terminal high-voltage DC.
ƒ′=ƒ+Δƒ_{HVDC}, (12)
Where,
Δƒ_{HVDC}=[Pₛ₁Q_{y1}PₛₖQₛₖ|P_{dc]}^{T}.

Also, unknown vectors in the iteration formula shall be modified, and direct-axis current at rectifier end is added into unknown vector of iteration formula as a status variable. Meanwhile, quadrature-axis current component can replace the position of voltage range in unknown vector only when it operates in an automatic voltage control mode. If assuming that reactive power compensation at rectifier end is targeted for a specified input of reactive power, and that at converter end targeted for a specified voltage range of bus, the status variables relating to HVDC transmission system are:
x_{HVDC}=[θₛ₁Vₛ₁θₛₖ|Iₛₕ₁^{D}Iₛₕₖ^{Q}]^{T}

Jacobin matrix element relating to HVDC is also required to be modified as follows:
J′=J+ΔJ_{HVDC}, (13)
Where,

$$Δ {J}_{HVDC} = [ \begin{matrix}0 & \frac{\partial {P}_{s 1}}{\partial {V}_{s 1}} & 0 & \vert & \frac{\partial {P}_{s 1}}{\partial {I}_{sh 1}^{D}} & 0 \\ 0 & \frac{\partial {Q}_{s 1}}{\partial {V}_{s 1}} & 0 & \vert & 0 & 0 \\ 0 & 0 & 0 & \vert & 0 & 0 \\ 0 & 0 & 0 & \vert & 0 & \frac{\partial {Q}_{sk}}{\partial {I}_{shk}^{Q}} \\ - & - & - & + & - & - \\ 0 & \frac{\partial {P}_{dc}}{\partial {V}_{s 1}} & 0 & \vert & \frac{\partial {P}_{dc}}{\partial {I}_{sh 1}^{D}} & \frac{\partial {P}_{dc}}{\partial {I}_{shk}^{Q}}\end{matrix} ] .$$

If control objectives of reactive power at rectifier end or converter end differ from the already mentioned assumptions, they can also be derived in the same way.

Equivalent Voltage of Voltage Source Converter (VSC)

When power flow solution is converged, parallel voltage source may be converted into an optimal voltage source connected in series to a proper impedance. After a simple algebraic operation, d-q axis component of equivalent parallel voltage source can be expressed as:

$$\begin{matrix}[ \begin{matrix}{V}_{sh 1}^{D} \\ {V}_{sh 1}^{Q}\end{matrix} ] = [ \begin{matrix}{V}_{s 1} \\ 0\end{matrix} ] - [ \begin{matrix}{R}_{sh 1} & - {X}_{sh 1} \\ {X}_{sh 1} & {R}_{sh 1}\end{matrix} ] [ \begin{matrix}{I}_{sh 1}^{D } \\ {I}_{sh 1}^{Q}\end{matrix} ] & ( 14 ) \\ [ \begin{matrix}{V}_{shk}^{D} \\ {V}_{shk}^{Q}\end{matrix} ] = [ \begin{matrix}{V}_{sk} \\ 0\end{matrix} ] + [ \begin{matrix}{R}_{shk} & - {X}_{shk} \\ {X}_{shk} & {R}_{shk}\end{matrix} ] [ \begin{matrix}{I}_{shk}^{D} \\ {I}_{shk}^{Q}\end{matrix} ] , for k = 2 n . & ( 15 )\end{matrix}$$

Where, Rₛₕₖ and Xₛₕₖ are resistance and impedance of coupling transformer linking VSCₖ. The polar coordinate of parallel voltage source is as follows:

$${V}_{shk} = {V}_{shk} {∠θ}_{shk} = \sqrt{{V}_{shk}^{{D}^{2}} + {V}_{shk}^{{Q}^{2}}} ∠ ( {tan}^{- 1} \frac{{V}_{shk}^{Q}}{{V}_{shk}^{D}} + {θ}_{sk} ) . \qquad ( 16 )$$

Case Analysis

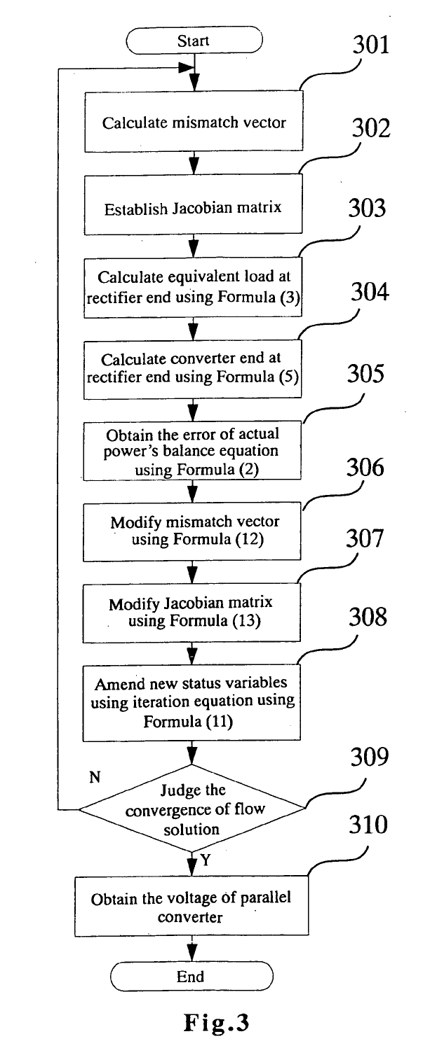

To verify the validity of the model of VSC-based Multi-terminal HVDC, MATPOWER 2.0 power flow calculating procedure is modified to induct this model. And, some controllers within the framework of parallel VSC are built-into IEEE 300 bus test system for simulation purpose. The case design aims to demonstrate that this model is applicable to power flow analysis for all controllers within the framework of parallel voltage source converter (VSC). In the present invention, IEEE 300-bus system is used to calculate power flow with introduction of a group of STATCOM, BTB HVDC, PTP HVDC and a Multi-terminal HVDC system. All controllers based on parallel VSC are implemented by following the flow process as shown in FIG. 3. The first step (301) is to calculate mismatch vector, then establish Jacobian matrix in step (302). Next, step (303) is to calculate equivalent load at rectifier end and converter end after using Park Conversion, and step (304)/(305) to obtain the error using active power's balance equation. Furthermore, step (306) is to consider and modify mismatch vector, followed by step (307) to modify Jacobian matrix, step (308) to amend new status variables using iteration equation, and step (309) to judge the convergence of flow solution. Otherwise, return to step (301) to recalculate mismatch vector. In the case of convergence, the final step(310) is to obtain the voltage of parallel converter. The test systems are described below:

Static Synchronous Compensator, BTB HVDC and PTP HVDC transmission systems are regarded as examples of VSC-based Multi-terminal HVDC transmission system. Static Synchronous Compensator, linked to line 71, is used to control the voltage. The rectifier end of BTB HVDC transmission system is linked to line 44, and sending end of line 44-62 re-linked to converter end of HVDC transmission system, called as 44′; Line 17-16 is replaced by a PTP HVDC transmission system. The rectifier end is linked to line 17 and converter end linked to line 16. Line 198-211 and line 198-197 are replaced by a M-VSC-HVDC. Line 198 is placed at rectifier end, line 211 and line 197 at two converter ends, respectively. The voltage of converter end is controlled at 1.0 per unit value (p.u.), and input reactive power at rectifier end controlled at 0 per unit value(p.u.)

Major control objectives of this case are set up in the same manner: The active power sent out from converter end is maintained at 120% of corresponding base load flow. DC transmission lines of PTP HVDC system and VSC-based Multi-terminal HVDC system set up a resistance the same as that of original AC transmission line. All coupling transformers are provided with the same impedance: Rₛₕₖ=0.01p.u. and Xₛₕₖ=0.05 p.u., maximum permissible mismatch vector is 1.0×10¹² p.u.. For setting-up of initial value of status variable, a flat start is applied to all bus voltages, while control variables relating to HVDC transmission system, e.g. converter's direct-quadrature-axis components, select an initial value of 0.

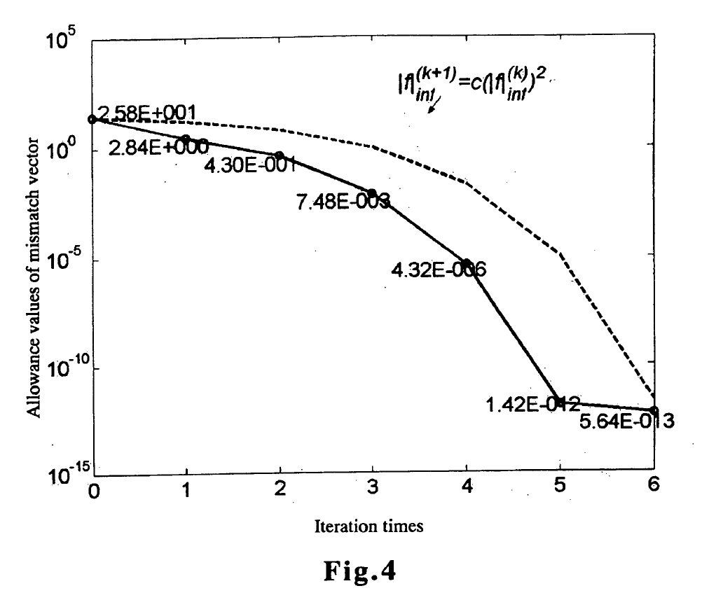

In this case, power flow solution is converged to a specified tolerance after 6 iterations, showing a convergence speed the same as in case of absence of any HVDC system. The flow solution is listed in Table 1, wherein the target values are at second column, showing that all controlled variables reach the target values. The black faced figures in third column refer to final values of status variables added into iteration formula, while the remaining quadrature-axis current components can be calculated by substituting into formula (4) or (7). It can be seen that, when the target value fed to AC power grid by VSC is 0, the corresponding quadrature-axis current is also 0. This shows that active/reactive power control of VSC is subjected to decoupling control via direct-quadrature-axis decomposition. It can be seen from the last column that, the loss of DC transmission line is 0 in the absence of DC transmission line in Static Synchronous Compensator and BTB HVDC transmission system. Subsequently, the active power's balance conditions can also be verified by the results at last two columns. As shown in FIG.4, all status variables of this case with an initial value of 0 are rapidly converged to the target values under different frameworks of HVDC. According to the formula in FIG. 4, |ƒ|_{inf}^{(k)} represents a maximum absolute value of mismatch vector after k iterations, and c is a constant. This formula means that the error of mismatch vector declines considerably with the increase of iteration times.

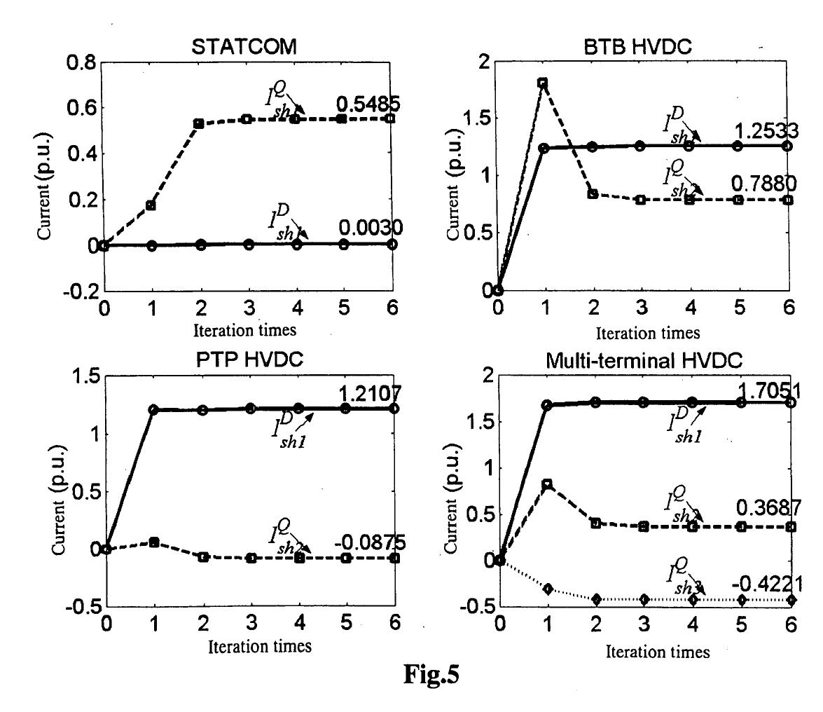

FIG. 5 shows a convergence mode for maximum absolute value of mismatch vector. Though the current exceeds the target value to a great extent after first iteration, subsequent iterations can enable it to be converged rapidly to the target value, and the margin of error is narrowed successively, so poorer estimation value of first iteration will not adversely affect overall convergence performance.

Thus, quadratic convergence feature can be maintained when the power system is equipped with controllers under the framework of parallel converter-based HVDC transmission systems (HVDC) with different configurations.

In brief, the aforementioned involve an innovative invention that can promote overall economic efficiency thanks to its many functions and active value. And, no similar products or equivalent are applied in this technical field, so it would be appreciated that the present invention is granted patent as it meets the patent-pending requirements.

What is claimed is:

1. A method of setting-up steady state model of VSC-based Multi-terminal HVDC transmission system, which is used to induct M-VSC-HVDC model into Newton-Raphson Power Flow Algorithm through an integration process, which mathematical model can be applied to all controllers composed of parallel voltage source converters (VSC).

2. A steady state model of VSC-based Multi-terminal HVDC transmission system, whereby every HVDC terminal of equivalent circuit can be expressed as a current source; the said current source includes two orthogonal components: direct-axis and quadrature- axis component, of which direct-axis component controls the transfer of active power and loss of coupling transformer, and quadrature-axis component has the control capability of reactive power.

3. The model defined in claim 2, wherein the active/reactive power fed to AC power grid from VSC can be foully decoupled through d-q-axis decomposition, thus reducing status variables added into iteration formula and realizing accurately the expected control objectives.

4. The model defined in claim 2, wherein reactive power compensation modes of every terminal are taken into consideration, and integrated successfully into a single solving process.

5. The model defined in claim 1, wherein if Newton-Raphson iteration method is used to calculate system flow solution, the steady state model of HVDC is expressed as a d-q axis component via Park Conversion using orthogonal projection technology, thus reducing the complexity of computational analysis.

6. The model defined in claim 1, wherein if the system is to calculate power flow solution, a little HVDC control parameters is added to iteration formula; in despite of the amount of parallel voltage source converters (VSC) and control mode of reactive power compensation, the length of mismatch vector increases only by 1.
J′=J+ΔJ_{HVDC},
Where:
$$Δ {J}_{HVDC} = [ \begin{matrix}0 & \frac{\partial {P}_{s 1}}{\partial {V}_{s 1}} & 0 & \vert & \frac{\partial {P}_{s 1}}{\partial {I}_{sh 1}^{D}} & 0 \\ 0 & \frac{\partial {Q}_{s 1}}{\partial {V}_{s 1}} & 0 & \vert & 0 & 0 \\ 0 & 0 & 0 & \vert & 0 & 0 \\ 0 & 0 & 0 & \vert & 0 & \frac{\partial {Q}_{sk}}{\partial {I}_{shk}^{Q}} \\ - & - & - & + & - & - \\ 0 & \frac{\partial {P}_{dc}}{\partial {V}_{s 1}} & 0 & \vert & \frac{\partial {P}_{dc}}{\partial {I}_{sh 1}^{D}} & \frac{\partial {P}_{dc}}{\partial {I}_{shk}^{Q}}\end{matrix} ] ,$$
J is corresponding Jacobian matrix, J′ is mismatch vector, and only few elements in Jacobian shall be modified, thus, quadratic convergence of Newton-Raphson algorithm is still maintained, presenting a good convergence characteristic.
